(19) United States
(12) Patent Application Publication
(10) Pub. No.: US 2025/0163538 A1
(43) Pub. Date: May 22, 2025

(54) PRECIPITATION SYSTEM FOR HYDROMETALLURGICAL PROCESSING OF LATERITE NICKEL ORE

(71) Applicants: PT QMB NEW ENERGY MATERIALS, Jakarta Selatan, Dki Jakarta (ID); PT ESG NEW ENERGY MATERIAL, Jakarta Selatan, Dki Jakarta (ID); GEM CO., LTD., SHENZHEN, GUANGDONG (CN); PT GEM INDONESIA NEW ENERGY MATERIALS, Jakarta Selatan, Dki Jakarta (ID)

(72) Inventors: KAIHUA XU, SHENZHEN, GUANGDONG (CN); SATRYO SOEMANTRI BRODJONEGORO, JAKARTA SELATAN, DKI JAKARTA (ID); RIZKY WANALDI, JAKARTA SELATAN, DKI JAKARTA (ID); TEGAR MUKTI AJI, JAKARTA SELATAN, DKI JAKARTA (ID); ANDI SYAPUTRA HASIBUAN, JAKARTA SELATAN, DKI JAKARTA (ID); EVAN WAHYU KRISTIYANTO, JAKARTA SELATAN, DKI JAKARTA (ID); NURUL LAILATUL MUZAYADAH, JAKARTA SELATAN, DKI JAKARTA (ID); WENZE LIU, JAKARTA SELATAN, DKI JAKARTA (ID); ARNALDO MARULITUA SINAGA, JAKARTA SELATAN, DKI JAKARTA (ID)

(21) Appl. No.: 18/870,461

(22) PCT Filed: Jun. 29, 2023
(86) PCT No.: PCT/CN2023/103769

§ 371 Date: Nov. 29, 2024

(51) Int. Cl. C22B 3/02; C22B 3/00; C22B 3/44

(52) U.S. Cl. CPC C22B 3/02; C22B 3/44; C22B 23/04

(57) ABSTRACT

Disclosed is a precipitation system for hydrometallurgical processing of laterite nickel ore, comprising a reaction tank, a feeding assembly, and a discharging assembly. Inside the reaction tank, there is a holding chamber; the feeding assembly comprises a first inlet pipe and a second inlet pipe; the discharging assembly comprises a material lifting pipe and a gas conduit; the gas conduit extends into the material lifting pipe below the liquid level. By introducing gas into the material lifting pipe through the gas conduit, bubbles are entrained in the solid-liquid mixture within the material lifting pipe, the liquid level within the material lifting pipe rises, ultimately causing the solid-liquid mixture at the bottom of the holding chamber to be discharged through the material lifting pipe. This allows for the direct extraction of precipitates from the bottom of the holding chamber, extending the period between manual cleanings of the reaction tank.

### FIELD OF THE DISCLOSURE

The disclosure relates to the technical field of metal smelting, in particular to a precipitation system for hydrometallurgical processing of laterite nickel ore.

### BACKGROUND

The hydrometallurgical processing technology for laterite nickel ore can handle low-grade laterite nickel ore, typically sourced from the limonitic layer and the transitional layer of the laterite nickel ore deposit.

In the hydrometallurgical processing of laterite nickel ore, altering the pH of the solution is often employed to precipitate metal ions in the solution, thereby removing them. The existing precipitation system for hydrometallurgical processing can be referred to in a patent with application number CN201711120629.X, which provided a device for removing iron from iron-containing solution by wet smelting, the device consists of a series of reactors and thickeners connected in sequence. The solution and neutralizing agent (alkali liquor) are mixed uniformly and then fed into the reactor. After passing through the reactor, the mixture flows into the thickener for thickening, resulting in iron-containing precipitate. However, some precipitate is also generated in the reactor, accumulating at the bottom and unable to flow into the next equipment, necessitating frequent manual cleaning.

Therefore, how to avoid the accumulation of sediment at the bottom of the reactor is an urgent technical problem to be solved.

### SUMMARY

The purpose of this disclosure is to provide a precipitation system for hydrometallurgical processing of laterite nickel ore to solve the technical problem of how to avoid the accumulation of sediment at the bottom of the reactor in the existing technology.

In order to solve the above technical problem, this disclosure provides a precipitation system for hydrometallurgical processing of laterite nickel ore, comprising a reaction tank, a feeding assembly, and a discharging assembly, wherein:
the reaction tank has a holding chamber within it;
the feeding assembly comprises a first inlet pipe and a second inlet pipe, where the second inlet pipe is connected to the first inlet pipe, and the first inlet pipe is connected to the holding chamber;
the discharging assembly comprises a material lifting pipe and a gas conduit, one end of the material lifting pipe is connected to the bottom of the holding chamber; the gas conduit extends into the material lifting pipe below the liquid level and supplies gas into the material lifting pipe, thereby raising the liquid level inside the material lifting pipe and enabling the substances within the material lifting pipe to be exported from its port.

Preferably, the feeding assembly further comprises a third inlet pipe, which is connected to the material lifting pipe.

Preferably, the third inlet pipe is connected to the end of the material lifting pipe that is closer to the holding chamber.

Preferably, the second inlet pipe partially extends into the first inlet pipe.

Preferably, the angle between the flow direction of the material in the first inlet pipe and the flow direction of the material in the second inlet pipe is an acute angle.

Preferably, the material lifting pipe comprises a main pipe and an auxiliary pipe, the main pipe is vertically installed and extends into the holding chamber, one end of the auxiliary pipe is connected to the main pip, and the other end of the auxiliary pipe is inclined downwards.

Preferably, a stopping valve is installed on the auxiliary pipe to control the opening and closing of the auxiliary pipe.

Preferably, a regulating valve is installed on the gas conduit to control the openness of the gas conduit.

Preferably, the precipitation system further comprises a mixing assembly, the mixing assembly comprises blades, a rotating shaft, and a driving device, the rotating shaft is rotatably installed within the holding chamber, and the blades are mounted on the rotating shaft, the driving device is drivingly connected to the rotating shaft to rotate it.

Preferably, the driving component comprises an electric motor, which is directly connected to the rotating shaft.

Compared with existing technologies, the beneficial effects of this disclosure are: firstly, introducing metal ion solution into the holding chamber through the first inlet pipe, and simultaneously introducing a neutralizing agent into the first inlet pipe via the second inlet pipe. This allows the neutralizing agent to mix with the metal ion solution before they enter the holding chamber together. As the pH increases upon mixing the metal ion solution with the neutralizing agent, metal ions form hydroxides and precipitate. These precipitates accumulate at the bottom of the holding chamber. Air is then introduced into the material lifting pipe through a gas conduit. Bubbles entrained in the solid-liquid mixture within the material lifting pipe reduce the overall density of the contents in the pipe, making it less dense than the contents in the holding chamber. Due to atmospheric pressure, the liquid level in the material lifting pipe rises, ultimately causing the solid-liquid mixture at the bottom of the holding chamber to be exported through the material lifting pipe. This disclosure utilizes the precipitation system for hydrometallurgical processing of laterite nickel ore, the precipitates at the bottom of the holding chamber can be directly exported, eliminating the need for frequent manual cleaning of residuals within the holding chamber and significantly extending the cycle for manual cleaning of the reaction tank.

### BRIEF DESCRIPTION OF THE DRAWINGS

FIG. 1 is a schematic diagram of the structure of the precipitation system for hydrometallurgical processing of laterite nickel ore in this disclosure.

### DETAILED DESCRIPTION OF PREFERRED EMBODIMENTS

In order to make the purpose, technical scheme and advantages of this disclosure clearer, this disclosure is further described in detail in the following part with the attached FIGURES and implementation examples. It should be understood that the specific embodiments described here are only used to explain this disclosure and are not used to limit this disclosure.

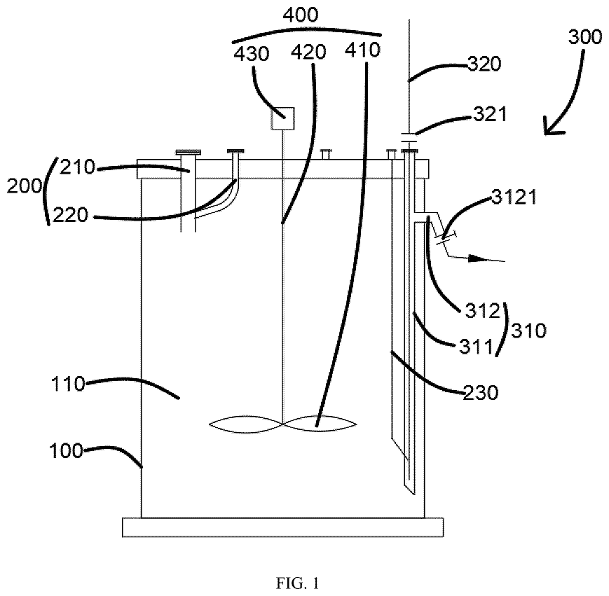

Please refer to FIG. 1, this disclosure provides an embodiment of a precipitation system for hydrometallurgical processing of laterite nickel ore, which belongs to the field of metal smelting. This precipitation system utilizes chemical reactions to precipitate metal ions in the solution and export the solid precipitates. By utilizing the aforementioned precipitation system for hydrometallurgical processing of laterite nickel ore, metal precipitates can be exported from the bottom of the reaction vessel, preventing the accumulation of precipitates and thereby extending the cycle for manual cleaning of the reaction vessel.

In some preferred embodiments, the precipitation system for hydrometallurgical processing of laterite nickel ore comprises a reaction tank 100, a feeding assembly 200, and a discharging assembly 300. Specifically, the reaction tank 100 has a holding chamber 110 within it. The feeding assembly 200 comprises a first inlet pipe 210 and a second inlet pipe 220, where the second inlet pipe 220 is connected to the first inlet pipe 210, and the first inlet pipe 210 is connected to the holding chamber 110. The discharging assembly 300 comprises a material lifting pipe 310 and a gas conduit 320. One end of the material lifting pipe 310 is connected to the bottom of the holding chamber 110. The gas conduit 320 extends into the material lifting pipe 310 below the liquid level and supplies gas into the material lifting pipe 310, thereby raising the liquid level inside the material lifting pipe 310 and enabling the substances within the material lifting pipe 310 to be exported from its port.

Firstly, the metal ion solution is introduced into the holding chamber 110 through the first inlet pipe 210, while the neutralizing agent is introduced into the first inlet pipe 210 via the second inlet pipe 220. This allows the neutralizing agent to mix with the metal ion solution before they enter the holding chamber 110 together. As the pH increases upon mixing the metal ion solution with the neutralizing agent, metal ions form hydroxides and precipitate. These precipitates accumulate at the bottom of the holding chamber 110. Air is then introduced into the material lifting pipe 310 through the gas conduit 320. Bubbles entrained in the solid-liquid mixture within the material lifting pipe 310 reduce the overall density of the contents in the pipe, making it less dense than the content in the holding chamber 110. Due to atmospheric pressure, the liquid level in the material lifting pipe 310 rises, ultimately causing the solid-liquid mixture at the bottom of the holding chamber 110 to be exported through the material lifting pipe 310. By utilizing the precipitation system for hydrometallurgical processing of laterite nickel ore provided in this disclosure, the precipitates at the bottom of the holding chamber 110 can be directly exported, eliminating the need for frequent manual cleaning of residuals within the holding chamber 110 and significantly extending the cycle for manual cleaning of the reaction tank 100.

It should be emphasized that the gas conduit 320 should be extended as close as possible to the bottom of the material lifting pipe 310, thus allowing more gas bubbles to be stored within the gas conduit 320 and subsequently increasing the liquid level height in the material lifting pipe 310. In existing equipment, the optimal position for the gas conduit 320 is to extend to a point between 15 cm and 22 cm from the bottom end of the material lifting pipe 310.

Furthermore, in the existing technology, homogenizing distributors are commonly used to mix neutralizing agents with metal ion solutions. However, this disclosure introduces a high-velocity flow of metal ion solution into the first inlet pipe 210, utilizing the high-speed fluid to promote thorough dispersion of the neutralizing agent within the metal ion solution.

It should be emphasized that the original design intention of this system is to address the hydrometallurgical processing of laterite nickel ore. It can be set up to provide appropriate reaction conditions such as pH, temperature, and pressure, for the reactive precipitation of various metal ions including iron, aluminum, nickel, cobalt, manganese, zinc, and others. In principle, any metal element that can undergo a reaction to form a solid precipitate within the reaction vessel is applicable.

In some preferred embodiments, there are multiple second inlet pipes 220, and these multiple second inlet pipes 220 are sequentially connected to the first inlet pipe 210 along the axial direction of the first inlet pipe 210. By utilizing multiple second inlet pipes 220, the neutralizing agent can be introduced into the metal ion solution in batches. Introducing the neutralizing agent in small, multiple batches allows for more thorough mixing between the metal ion solution and the neutralizing agent.

In some preferred embodiments, the feeding assembly 200 further comprises a third inlet pipe 230, which is connected to the material lifting pipe 310. Through the third inlet pipe 230, additional neutralizing agent can be introduced into the material lifting pipe 310. The neutralizing agent is rapidly mixed with the metal ion solution under the action of the ascending air bubbles in the material lifting pipe 310, causing the metal ions that have not yet precipitated in the material lifting pipe 310 to react and precipitate quickly. Meanwhile, the excess neutralizing agent in the material lifting pipe 310 does not alter the pH of the metal ion solution in the holding chamber 110, thereby not changing the reaction conditions within the holding chamber 110.

Based on the aforementioned embodiments, in some preferred embodiments, the third inlet pipe 230 is connected to the end of the material lifting pipe 310 that is closer to the holding chamber 110. This configuration allows for an extended travel distance of the neutralizing agent introduced through the third inlet pipe 230 within the material lifting pipe 310, thereby prolonging the duration of the metal ion reaction.

In some preferred embodiments, the second inlet pipe 220 partially extends into the first inlet pipe 210. This allows the neutralizing agent introduced through the second inlet pipe 220 to reach the center of the first inlet pipe 210, and subsequently, with the flushing action of the metal ion solution, it can be quickly dispersed throughout the metal ion solution.

In some preferred embodiments, the angle between the flow direction of the material in the first inlet pipe 210 and the flow direction of the material in the second inlet pipe 220 is an acute angle. Due to this acute angle between the flow directions of the materials in the first inlet pipe 210 and the second inlet pipe 220, the kinetic energy loss of the metal ion solution can be minimized as much as possible.

In some preferred embodiments, the material lifting pipe 310 comprises a main pipe 311 and an auxiliary pipe 312. The main pipe 311 is vertically installed and extends into the holding chamber 110. One end of the auxiliary pipe 312 is connected to the main pipe 311, and the other end of the auxiliary pipe 312 is inclined downwards. When the gas conduit 320 supplies air into the main pipe 311, the material level inside the main pipe 311 continuously rises until it reaches the juncture of the auxiliary pipe 312 and the main pipe 311, allowing the material to gradually be discharged through the auxiliary pipe 312.

In some preferred embodiments, a stopping valve 3121 is installed on the auxiliary pipe 312 to control the opening and closing of the auxiliary pipe 312. Similarly, a regulating valve 321 is installed on the gas conduit 320 to control the openness of the gas conduit 320. By adjusting the openness of the gas conduit 320 with the regulating valve 321, the flow rate of the gas introduced into the material lifting pipe 310 can be controlled.

In some preferred embodiments, the bottom surface of the reaction tank 100 is designed as an inclined plane that slopes towards the material lifting pipe 310. Under the guidance of this inclined plane, precipitates can be directed to accumulate near the material lifting pipe 310, facilitating the removal of solid precipitates.

In some preferred embodiments, the precipitation system for hydrometallurgical processing of laterite nickel ore further comprises a mixing assembly 400. The mixing assembly 400 comprises blades 410, a rotating shaft 420, and a driving device 430. The rotating shaft 420 is rotatably installed within the holding chamber 110, and the blades 410 are mounted on the rotating shaft 420. The driving device 430 is drivingly connected to the rotating shaft 420 to rotate it. By utilizing the driving device 430 to rotate the rotating shaft 420 and the blades 410, the metal ion solution can be agitated, thereby facilitating the reaction rate of the metal ions. Additionally, the driving device 430 is preferably an electric motor, which is directly connected to the rotating shaft 420 to drive its rotation.

It should be emphasized that both the second inlet pipe 220 and the third inlet pipe 230 are used for introducing neutralizing agents. Operators can, based on process conditions, introduce neutralizing agents of different concentrations or even different types through the second inlet pipe 220 and the third inlet pipe 230, respectively. This allows for a more efficient precipitation of metal ions through reaction.

Firstly, the metal ion solution is introduced into the holding chamber 110 through the first inlet pipe 210, and a neutralizing agent is introduced into the first inlet pipe 210 via the second inlet pipe 220. This allows the neutralizing agent and the metal ion solution to mix together before entering the holding chamber 110. Due to the increase in pH after mixing the metal ion solution and the neutralizing agent, metal ions will form hydroxides and precipitate. The precipitates will accumulate at the bottom of the holding chamber 110. The rotating shaft 420 and blades 410 are driven by the driving device 430 to stir the metal ion solution, facilitating the reaction rate of the metal ions. Air is introduced into the material lifting pipe 310 through the gas conduit 320. The presence of bubbles in the solid-liquid mixture within the material lifting pipe 310 causes the overall density of the material inside the pipe to be less than that of the material in the holding chamber 110. Under the action of atmospheric pressure, the liquid level inside the material lifting pipe 310 rises, ultimately allowing the solid-liquid mixture at the bottom of the holding chamber 110 to be exported through the material lifting pipe 310. By utilizing the precipitation system for hydrometallurgical processing of laterite nickel ore disclosed herein, precipitates at the bottom of the holding chamber 110 can be directly exported, avoiding the need for frequent manual cleaning of residues within the holding chamber 110 and significantly extending the cycle for manual cleaning of the reaction tank 100.

The specific embodiments described above do not constitute limitations on the scope of protection of this disclosure. Any other corresponding changes and modifications made according to the technical concept of this disclosure should be included within the scope of protection of the claims of this disclosure.

What is claimed is:

1. A precipitation system for hydrometallurgical processing of laterite nickel ore, comprising a reaction tank, a feeding assembly, and a discharging assembly, wherein:
the reaction tank has a holding chamber within it;
the feeding assembly comprises a first inlet pipe and a second inlet pipe, where the second inlet pipe is connected to the first inlet pipe, and the first inlet pipe is connected to the holding chamber;
the discharging assembly comprises a material lifting pipe and a gas conduit, one end of the material lifting pipe is connected to the bottom of the holding chamber; the gas conduit extends into the material lifting pipe below the liquid level and supplies gas into the material lifting pipe, thereby raising the liquid level inside the material lifting pipe and enabling the substances within the material lifting pipe to be exported from its port.

2. The precipitation system for hydrometallurgical processing of laterite nickel ore according to claim 1, wherein the feeding assembly further comprises a third inlet pipe, which is connected to the material lifting pipe.

3. The precipitation system for hydrometallurgical processing of laterite nickel ore according to claim 2, wherein the third inlet pipe is connected to the end of the material lifting pipe that is closer to the holding chamber.

4. The precipitation system for hydrometallurgical processing of laterite nickel ore according to claim 1, wherein the second inlet pipe partially extends into the first inlet pipe.

5. The precipitation system for hydrometallurgical processing of laterite nickel ore according to claim 4, wherein the angle between the flow direction of the material in the first inlet pipe and the flow direction of the material in the second inlet pipe is an acute angle.

6. The precipitation system for hydrometallurgical processing of laterite nickel ore according to claim 1, wherein the material lifting pipe comprises a main pipe and an auxiliary pipe, the main pipe is vertically installed and extends into the holding chamber, one end of the auxiliary pipe is connected to the main pip, and the other end of the auxiliary pipe is inclined downwards.

7. The precipitation system for hydrometallurgical processing of laterite nickel ore according to claim 6, wherein a stopping valve is installed on the auxiliary pipe to control the opening and closing of the auxiliary pipe.

8. The precipitation system for hydrometallurgical processing of laterite nickel ore according to claim 1, wherein a regulating valve is installed on the gas conduit to control the openness of the gas conduit.

9. The precipitation system for hydrometallurgical processing of laterite nickel ore according to claim 1, wherein the precipitation system further comprises a mixing assembly, the mixing assembly comprises blades, a rotating shaft, and a driving device, the rotating shaft is rotatably installed within the holding chamber, and the blades are mounted on the rotating shaft, the driving device is drivingly connected to the rotating shaft to rotate it.

10. The precipitation system for hydrometallurgical processing of laterite nickel ore according to claim 9, wherein the driving component comprises an electric motor, which is directly connected to the rotating shaft.
